(19) United States
(12) Patent Application Publication
(10) Pub. No.: US 2024/0389163 A1
(43) Pub. Date: Nov. 21, 2024

(54) Systems and Methods for Enabling Non-3GPP Devices Without 3GPP Signaling Capability to Communicate on 3GPP-based Communications Networks

(71) Applicant: MITRE Corporation, McLean, VA (US)

(72) Inventors: Ing-Wher Chen, McLean, VA (US); Shukri Abdallah, McLean, VA (US); Venkatesh Ramaswamy, McLean, VA (US); Feng Xie, McLean, VA (US)

(21) Appl. No.: 18/199,806

(22) Filed: May 19, 2023

(51) Int. Cl. H04W 76/10; H04W 12/06

(52) U.S. Cl. CPC H04W 76/10; H04W 12/068

(57) ABSTRACT

A device and method are described for enabling a non-3GPP device without 3GPP signaling capability to communicate on a 3GPP-based communications network. The device includes a physical layer configured to receive non-3GPP signaling waveforms from an end user device (EUD). The device also includes a network interface communicatively coupled to a 3GPP core network, and one or more processors. The processors are configured to establish a connection with the 3GPP-based core network using a 3GPP credential. The processors receive a first network address allocated by the 3GPP-based core network, and associate the first network address with the EUD. Next, a data payload is extracted from a waveform received from the EUD via the physical layer. Then the data payload is encapsulated in outgoing Internet Protocol (IP) packets, a source header of the outgoing IP packets including the first network address. The IP packets are then transmitted to the 3GPP-based core network via the network interface.

### TECHNICAL FIELD

The present application pertains to systems and methods enabling non-3GPP devices without 3GPP signaling capability to communicate on 3GPP-based communications networks. As an example, the present application pertains to systems and methods for enabling non-3GPP devices to communicate over a 5G network using a proxy device.

### BACKGROUND

Standardized 5G technology provides data transport from an end user device (EUD) to a data network. There are many types of user equipment that can benefit from establishing such a data path using 5G technology, however, there are barriers to achieving this objective. For example, the number of EUDs to be upgraded to include 5G/3GPP signaling may be too large and/or the cost of upgrading some or all of the EUDs may be prohibitive.

Moreover, many proprietary communications systems cannot be “upgraded” to 5G technology for various reasons. For example, some proprietary radio waveforms have unique characteristics that 5G New Radio (NR) waveforms do not have, such as anti-jamming, low probability of interception (LPI), or low probability of detection (LPD). Also, some legacy devices cannot be upgraded to run 5G signaling software.

### SUMMARY

The following describes a device for enabling a non-3GPP device without 3GPP signaling capability to communicate on a 3GPP-based communications network. The device includes a physical layer configured to receive non-3GPP signaling waveforms from an end user device (EUD). The device also includes a network interface communicatively coupled to a 3GPP core network, and one or more processors. The processors are configured to establish a connection with the 3GPP-based core network using a 3GPP credential. The processors receive a first network address allocated by the 3GPP-based core network, and associate the first network address with the EUD. Next, a data payload is extracted from a waveform received from the EUD via the physical layer. Then the data payload is encapsulated in outgoing Internet Protocol (IP) packets, a source header of the outgoing IP packets including the first network address. The IP packets are then transmitted to the 3GPP-based core network via the network interface.

The following also describes a method for enabling a non-3GPP end user device (EUD) without 3GPP signaling capability to communicate on a 3GPP-based communications network. A connection is established with a 3GPP-based core network using a 5G credential. A first network address allocated by the 3GPP-based core network is received. The first network address is associated with the EUD. A data payload is extracted from a waveform received from the EUD via a physical layer configured to receive non-3GPP signaling waveforms from the EUD. The data payload is encapsulated in outgoing Internet Protocol packets, a source header of the outgoing IP packets including the first network address. The IP packets are transmitted to the 3GPP-based core network via the network interface.

### BRIEF DESCRIPTION OF THE DRAWINGS

Embodiments of the present disclosure will be described with reference to the accompanying drawings, in which:

FIG. 1 illustrates a system in which a non-3GPP device communicates through a 5G core network, in accordance with some embodiments.

FIG. 2 illustrates an example of a proxy configured for enabling a non-3GPP device to communicate through a 5G core network.

FIG. 3 is a flow diagram of a process by a proxy for enabling a non-3GPP device to communicate through a 5G core network, in accordance with some embodiments.

FIG. 4 is a flow diagram of a process by an IP adapter for enabling a non-3GPP device that uses a non-IP-based network layer to communicate through a 5G Core Network, in accordance with some embodiments.

### DETAILED DESCRIPTION

The present disclosure enables a non-3GPP end user device (EUD) to communicate through a 3GPP network, such as a 5G Core Network. More specifically, embodiments of the present disclosure use a proxy that sends and receives data to and from the 5G core network on behalf of a non-3GPP device. The disclosed systems and methods enable a non-3GPP device to take advantage of features offered by a 3GPP network, such as security, reliability, and lower cost, without modifying the software or hardware of non-3GPP devices.

As used herein, a “waveform” refers to the signal received at a physical layer of a device (e.g., EUD).

A “network interface” refers to a hardware component that an EUD uses to communicate via a particular communications system (e.g., WiFi, 5G, Satellite).

As used herein, a “non-3GPP” End User Device (EUD) refers to an EUD having a network interface that is incapable of communicating within the range of the spectrum allocated to 5G or is incapable of communicating using 5G protocols. Under the context of “5G”, 3GPP and 5G are equivalent. 3GPP capable devices have both 5G NR radio waveform and 5G signaling protocols to connect to a 5G core network and thus do not need a proxy (as described below). Non-3GPP devices that do not have 5G NR radio waveforms but support 5G signaling protocols can use network functions such as N3IWF (non-3GPP Interworking Function) as a non-3GPP access gateway to connect to a 5G core network, and so they do not require a proxy either. (N3IWF is one of four specified inter-working functions that non-3GPP devices can use, and they are used under different conditions.) Only those non-3GPP devices that do not support 5G signaling protocols (most likely, they do not have 5G NR radio waveform either), need to use proxy to connect to the core. In summary, a non-3GPP access gateway such as N3IWF allows non-3GPP radio waveforms to connect to the 5G core, whereas a proxy allows devices without 5G signaling capability to connect. The proxy is therefore used for such devices that do not have a 5G-capable radio interface and also cannot perform 5G signaling.

A non-3GPP device may be a hybrid device that includes both a 3GPP-capable network interface (e.g., 5G NR) and a non-3GPP network interface (e.g., WiFi).

As used herein, a “5G credential” refers to Universal Subscriber Identity Module (USIM) and Subscriber Permanent Identifier (SUPI).

As used herein, “Non Access Stratum (NAS) Capable Device” refers to a device that contains the NAS software needed to establish a 5G session with the 5G core. (As discussed previously, 5G signaling is used for establishing a 5G session.) The establishment of a session includes the establishment of a data path that provides IP transport from the EUD to the 5G core to a data network accessible by the 5G core.

As used herein, “NAS Incapable Device” refers to a device that does not contain the NAS software needed to establish a 5G session with the 5G core.

As used herein, a “3GPP-Capable Device” is a device that has a radio that supports the 5G New Radio (NR) access technology. A “Non-3GPP capable device” is a device that has a radio that supports access technologies other than 5G NR.

As used herein, “5G Credentials” are the information issued by a 5G provider to a subscriber (EUD) to authenticate the subscriber as an authorized user of the services provided by the 5G core to that subscriber.

As used herein, a “proxy” is 5G signaling software that communicates over the NAS functional layer towards the 5G core. It also keeps track of the 5G credentials to use to authenticate EUDs with the 5G core. Unlike the case of an EUD authenticating directly with the 5G core where each EUD has a unique 5G credential, the “proxy” may use a single 5G credential to establish a single 5G session on behalf of one EUD or on behalf of many EUDs. Thus, the 5G credentials may have one-to-one relationship to a EUD (i.e., one 5G credential for one EUD), one-to-many relationship (i.e., one 5G credential for many EUDs), or many-to-many relationship (i.e., a set of 5G credentials for a non-equal set of EUDs). The type of 5G credentials and EUD relationship is policy based. The proxy also supports the detection of the presence and disappearance of an EUD. All NAS-Incapable devices are required to use a proxy.

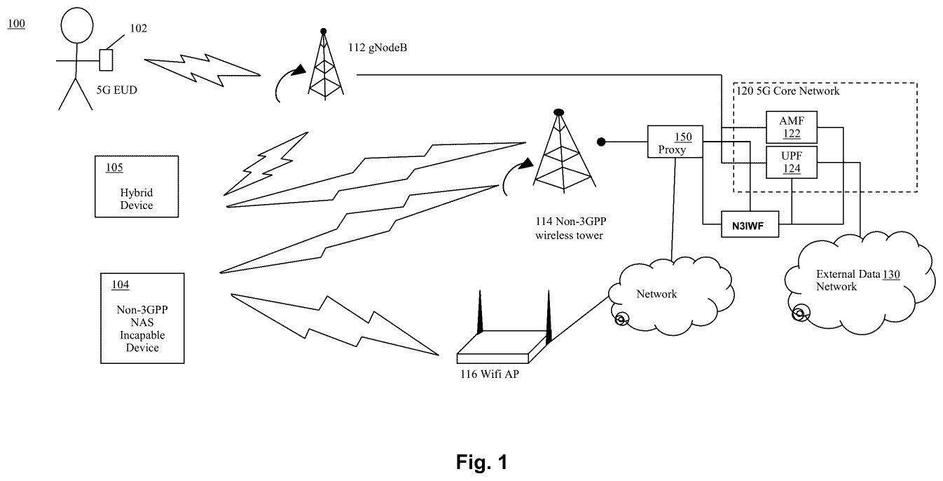

FIG. 1 illustrates a system 100 for enabling a non-3GPP device 104 to communicate through a 5G core network 120, in accordance with some embodiments. As shown in FIG. 1, system 100 includes a 5G core network 120, which is capable of communicating with a 5G EUD 102 via a gNodeB 112. More specifically, in the example of FIG. 1, 5G device 102 has access to a 5G credential (e.g., stored in a SIM card), and when using that 5G credential, the 5G EUD may establish registration for access control to the 5G network (a control plane connection) and a Protocol Data Unit (PDU) session for user plane data communication with AMF 122 (Access and Mobility Management Function) and UPF 124 (User Plane Function) of 5G core network 120, respectively. As part of the process for establishing these connections, 5G core network 120 allocates an IP address for the EUD. Subsequently, using the established user plane connection (and the allocated IP address), the 5G EUD 102 may send and receive data to and from 5G core network 120 and/or to and from an external data network 130 via 5G core network 120. As used herein, the phrase “communicating through” 5G core network 120 refers to both communicating with a device that is part of 5G core network 120 (e.g., AMF, UPF, other UEs) as well as communicating with a device in the external data network 130 (e.g., public web server) that is accessible via the 5G Core Network.

System 100 further includes a proxy 150 that enables a non-3GPP NAS incapable device 104 to communicate through 5G core network 120. A proxy is a network element that performs necessary signaling between an End User Device over a non-3GPP access gateway to the 5G core. Put another way, a proxy is a component that connects non-3GPP NAS incapable end devices to a 5G core network. In the example of FIG. 1, proxy 150 has access to at least one 5G credential, which proxy 150 uses to communicate with 5G core network 120 on behalf of one or more non-3GPP NAS incapable devices. More specifically, proxy 150 uses an accessible 5G credential to establish control plane/user plane connection pairs with AMF and UPF of 5G core network 120, respectively. Subsequently, when proxy 150 receives data from non-3GPP NAS incapable device 104 intended for 5G core network 120 (i.e., destined for 5G core network 120 or external data network 130), proxy 150 repackages (e.g., encapsulating as packets) the payload within the received data and transmits it towards 5G core network 120 using the established control plane and user plane connections. The data received at proxy 150 from non-3GPP NAS incapable device 104 is considered to be intended for 5G core network 120 to communicate with a device accessible via 5G core network 120 (e.g., a device in external data network 130). Conversely, when proxy 150 receives data from 5G core network 120 intended for non-3GPP NAS incapable device 104, proxy 150 repackages the payload within the received data and transmits it to non-3GPP NAS incapable device 104.

To determine that the received data is intended for non-3GPP NAS incapable device 104, proxy 150 may maintain a map (or index) of an IP address(es) allocated by 5G core network 120 and their associated device(s). For example, proxy 150 may maintain a table wherein each row includes an IP address allocated by 5G core network 120 and is associated with one or more associated non-3GPP NAS incapable devices 104 (represented by columns). Non-3GPP NAS incapable device 104 may be identified using an identifier that proxy 150 may use to reach the device (distinct from the IP address allocated by 5G core network 120); for example, this identifier may be another IP address (distinct from the IP address allocated by 5G core network 120), a MAC address, an Automatic Link Establishment address for modern HF, and a calls sign used for old-fashioned HF or amateur radio. The received data at proxy 150 from 5G core network 120 is considered intended for non-3GPP NAS incapable device 104 when the IP headers of the received data packets include as their destination an IP address mapped to non-3GPP NAS incapable device 104. The detailed process performed by proxy 150 is described below with respect to subsequent figures.

In some embodiments, proxy 150 may be configured such that proxy 150 is transparent to 5G core network 120. That is, proxy 150 may be configured such that 5G core network 120 is unaware that proxy 150 is acting as an intermediary to non-3GPP NAS incapable device 104. In some embodiments, proxy 150 may use information associated with non-3GPP NAS incapable device 104 (e.g., its MAC address, device ID, etc.) to establish the control plane/user plane connections such that, from the perspective of 5G core network 120, the control plane/user plane connections are made directly with the non-3GPP device. In some embodiments, proxy 150 may use its own information or generated information to establish control plane/user plane connections. In these embodiments, the identity of a non-3GPP NAS incapable device 104 (i.e., its device ID, MAC address etc.) may be hidden from 5G core network 120.

In some embodiments, proxy 150 may intercept data intended for the non-3GPP NAS incapable device 104. That is, in place of, or in addition to, repackaging and transmitting the data received from 5G core network 120, proxy 150 may process the data for itself. For example, the data from 5G core network 120 may be an instruction to terminate control plane/user plane connections associated with a particular 5G credential. In this example, proxy 150 may not transmit the data to non-3GPP NAS incapable device 104. Instead, proxy 150 may process the instruction to terminate the specified control plane/user plane connections or attempt to reestablish the connections. In some embodiments, the data from 5G core network 120 may be intended for non-3GPP NAS incapable device 104 that is only capable of transmitting data (i.e., a unidirectional device or a device in a unidirectional mode). In these embodiments, proxy 150 may be configured to save the received data (e.g., for a batch transfer to the non-3GPP NAS incapable device 104 at a later time) or ignore the data.

An example of a command that the 5G core can issue to a EUD that the proxy can intercept and process could be a paging or alert signal issued by the 5G core to 3GPP devices. The 5G core will deliver these messages/signals to a proxy. However, since non-3GPP NAS incapable devices served by the proxy do not support these functionalities, the proxy either silently drops these signals/messages or translates to the corresponding device-specific messages before sending them to the non-3GPP NAS incapable end devices.

In some embodiments, proxy 150 may have access to a plurality of 5G credentials. In these embodiments, proxy 150 may select a 5G credential among the plurality of credentials based on the identity of non-3GPP NAS incapable device 104, the type of traffic/protocol, and/or predetermined rules/policy. In some embodiments, a 5G credential may be dynamically selected (e.g., based on traffic type, rules/policy, etc.) at the time proxy 150 receives data from 5G core network 120 or from non-3GPP NAS incapable device 104. Alternatively, or additionally, a predetermined non-3GPP NAS incapable device 104 may be associated with a 5G credential when proxy 150 makes the control plane/user plane connections using the 5G credential.

As shown in FIG. 1, proxy 150 is communicatively coupled to both the communications system for non-3GPP NAS incapable device 104 (e.g., a non-3GPP wireless tower 114 or WiFi Access Point 116) and 5G core network 120. In some embodiments, proxy 150 may be a distinct device from 5G core network 120. In these embodiments, proxy 150 may be communicatively coupled to the 5G core network using IP-based network connections. In other embodiments, proxy 150 may be a part of 5G core network 120. For example, proxy 150 may be executed on the same device as one or more components (e.g. AMF, UPF) of the 5G Core Network. In some embodiments, proxy 150 may be a part of the communications system for non-3GPP NAS incapable device 104 (e.g., WiFi, proprietary wireless system). For example, if non-3GPP NAS incapable device 104 uses a CDMA technology, proxy 150 may be a part of a CDMA wireless tower 114 that receives wireless signals from such a device. In another example, if non-3GPP NAS incapable device 104 is a WiFi device, proxy 150 may be a part of WiFi Access Point 116.

In the example of FIG. 1, proxy 150 may also enable the non-3GPP network interface of a hybrid device 105 to communicate through 5G core network 120. Hybrid device 105 refers to a device that includes both a 5G NR network interface and another non-3GPP network interface (e.g., WiFi). Thus, in these embodiments, hybrid device 105 may communicate with 5G core network 120 via two distinct communication paths.

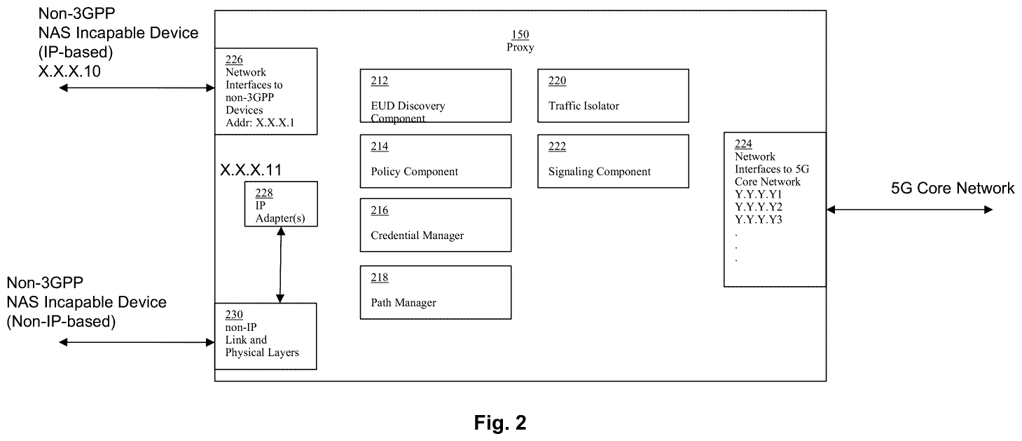

FIG. 2 is a high-level schematic block diagram example of proxy 150 in accordance with some embodiments. In the example of FIG. 2, proxy 150 includes an EUD discovery component 212, a policy component 214, a credential manager 216, a path manager 218, a traffic isolator 220, a signaling component 222, network interface(s) 226 to non-3GPP NAS incapable devices 104, network interface(s) 224 to 5G core network 120, and an IP Adapter 228.

EUD discovery component 212 is configured to detect the presence and/or absence of a non-3GPP NAS incapable device 104. How this occurs may depend on the type of EUD. For example, if an EUD supports IP, and it connects with the proxy via Ethernet or Wi-Fi, then the proxy can use ARP (address resolution protocol) requests sent by the EUD for discovery. As another example, if an EUD uses a radio waveform to connect with the proxy, then the proxy can use the signal strength and special signals sent by the EUD for discovery. Once the proxy discovers a new EUD, which has the appropriate permission to communicate with the proxy, the proxy may start signaling a connection with the 5G core network on behalf of the EUD.

Policy component 214 is configured to store and manage configurable policies that govern behavior of the proxy 150 with respect to the detected EUDs. For example, a policy may determine whether a detected device should be associated with its own 5G credential(s) or whether the device can share a 5G credential(s) with other devices. In some embodiments, a policy may govern the treatment of traffic from the proxy 150 back to the EUD. For example, the traffic from an EUD may arrive at the proxy 150 via its one or more network interfaces (e.g., from several different Wi-Fi access points that are connected to proxy 150). A policy may require proxy 150 to use a particular network interface when sending data (e.g., received from 5G core network 120 or an external data network via 5G core network 120) to the EUD regardless of the network interface the EUD used to communicate with proxy 150.

In some embodiments, the policy data may be stored within proxy 150. Alternatively, or additionally, the policy data may be stored outside proxy 150. In some embodiments, policy component 214 may have access to a single policy (e.g., hardcoded). Alternatively, or additionally, policy component 214 may have access to a plurality of policies that can be dynamically applied.

Credential manager 216 is configured to store and manage 5G credentials that proxy 150 can use to establish control plane/user plane connections with 5G core network 120. In some embodiments, credential manger 216 may have access to a single credential. Alternatively, or additionally, credential manger 216 may have access to a plurality of credentials.

Path manager 218 is configured to control data traffic between non-3GPP NAS incapable device 104 and proxy 150. Based on the applied policy, path manager 218 determines which path is used to transmit to a non-3GPP NAS incapable device 104 the data traffic arriving from 5G core network 120 (or an external data network via 5G core network 120).

Traffic isolator 220 is configured to isolate, based on the applied policy, communications with a particular non-3GPP NAS incapable device from communications from other devices.

Signaling component 222 is configured to establish, using a 5G credential selected for non-3GPP NAS incapable device 104 (e.g., by credential manager 216 and/or based on a policy applied by policy component 214), control plane/user plane connections with various components (e.g., AMF and UPF) of 5G core network 120. More specifically, signaling component 222 may communicate with AMF of 5G core network 120 to register an EUD and establish a control plane connection. An example registration process is described, for example, at 3GPP TS 24.501

Furthermore, signaling component 222 may communicate, via a non-3GPP access gateway such as N3IWF, with UPF of 5G core network 120 to obtain an IP address (e.g., Y.Y.Y.Y #) and establish a user plane connection. From 5G Core Network 120's perspective, this IP address is allocated to non-3GPP NAS incapable device 104. Thus, 5G core network (and data networks that are connected thereto) uses this allocated IP address to communicate with non-3GPP NAS incapable device 104. That is, 5G core network 120 uses this IP address as the destination address for sending data to non-3GPP NAS incapable device 104, and proxy 150 uses this IP address as the source address when transmitting data from non-3GPP NAS incapable device 104 towards 5G core network 120. In actuality, however, data packets that are destined for the IP address are routed to network interface 224 of proxy 150 and not directly to the non-3GPP NAS incapable device 104. The proxy 150 determines that the IP address is associated with the non-3GPP NAS incapable device 104, repackages the payload within the received data, and transmits it to non-3GPP NAS incapable device 104. Since 5G core network 120 allocates the IP address using a 5G credential that proxy 150 selected for a particular non-3GPP NAS incapable device 104 (e.g., based on an applied policy), the allocated IP address is considered to be “associated” with both the 5G credential and non-3GPP NAS incapable device 104.

After the control plane and user plane connections are established, the proxy maintains all the states that a normal 5G EUD has: Connection Management (CM) states (IDLE and CONNECTED) and Registration Management (RM) states (REGISTERED and DEREGISTERED). At a minimum, the signaling component 222 performs necessary procedures such that the control plane and user plane connections remain established. The key for the proxy is to perform what is necessary to keep the states in RM-REGISTERED and CM-CONNECTED and not lose connection with the 5G core. TS 24.502 Section 7.8 discusses a UE-initiated liveness check and 7.9 discusses a network-initiated liveness check procedure, both between a non-3GPP NAS incapable device and the 5G core network. TS 23.501 discusses that for some Non-3GPP access gateways, loss of connection is determined by IKEv2's Dead Peer Detection (defined in RFC 7296), where there are no responses from the peer within a certain amount of time. Other Non-3GPP access gateways use other mechanisms. Accordingly, signaling component 222 may be further configured to respond to messages intended to detect liveness of peers to maintain the connection between the proxy 150 and the 5G Core Network 120. Transitions in the state machine can be as follows:

(1) To access 5G core, the sequence is RM-DEREGISTERED, RM-REGISTERED, CM-IDLE, to CM-CONNECTED, where CM-CONNECTED is the state after a control plane connection is established.

(2) At RM-REGISTERED state, EUD may go to RM-DEREGISTERED state.

This occurs when EUD disconnects.

(3) When a dead peer is detected, this causes state to change to CM-IDLE, which triggers a UE Non-3GPP deregistration timer, and when UE Non-3GPP Deregistration Timer expires, this moves EUD to RM-DEREGISTERED state.

In some embodiments, the identity of the non-3GPP NAS incapable device may be obfuscated or otherwise hidden from the 5G core network 120. What EUD information is revealed to the core depends on policies. Ideally, except for the credentials that a proxy maintains, nothing about EUD devices needs to be revealed. It is desirable in some mission critical use cases to hide the EUD information such as identity, location, etc., from the 5G core network. Therefore, when establishing the control plane connection, proxy 150 may randomly choose a 5G credential to eliminate association of location with a particular 5G credential or retire previously used 5G credentials.

In some embodiments, credential manager 216 may maintain a table (or other data structure) that stores a list of the established control plane/user plane connections pairs and their associated non-3GPP NAS incapable device 104 (i.e., the device that caused proxy 150 to establish the connections), the IP address allocated by 5G core network 120 for the connections, the 5G credential used to establish the connections, and/or any other network address that proxy 150 can use to communicate with non-3GPP NAS incapable device 104 (e.g., IP address, MAC address, etc.). In some embodiments, an additional non-3GPP NAS incapable device 104 may be associated with established connections (e.g., if an applied policy allows multiple devices to be associated with a single 5G credential or if a policy allows a particular non-3GPP NAS incapable device to share a 5G credential with another device).

In embodiments where credential manager 216 has access to a plurality of credentials, signaling component 222 may be configured to establish a plurality of control plane/user plane connection pairs using a plurality of 5G credentials. In these embodiments, network interface 224 of proxy 150 is allocated a plurality of IP addresses by 5G core network 120.

In some embodiments, signaling component 222 may be further configured to maintain the established connection(s). For example, signaling component 222 may send a heartbeat signal (e.g., randomly generated data packets) towards the 5G core network 120 to prevent the connections from being timed out. In other embodiments, signaling component 222, based on an applied policy, will disassociate a connection pair with non-3GPP NAS incapable device 104 without terminating the connection. The disassociated connections may be re-associated with another non-3GPP NAS incapable device at a later time.

If the non-3GPP NAS incapable device uses IP as the network layer, proxy 150 may send and receive data to and from non-3GPP NAS incapable device 104 using network interface(s) 226. As shown in FIG. 2, non-3GPP NAS incapable device 104 may be allocated an IP address (e.g., X.X.X. 10), by proxy 150 or a DHCP server, and proxy 150 may send and receive data to and from non-3GPP NAS incapable device 104 using this IP address. This IP address is distinct from the IP address allocated by 5G core network 120. In the example of FIG. 2, when proxy 150 receives, at network interface 224, IP packets from 5G core network 120 intended for non-3GPP NAS incapable device 104 (which is IP-capable), proxy 150 replaces the destination address from Y.Y.Y.Y1 (allocated by 5G core network and used to reach proxy 150) with X.X.X.10 and retransmits the packets using network interface 226. Conversely, in the example of FIG. 2, when proxy 150 receives, at network interface 226, IP packets from non-3GPP NAS incapable device 104, proxy 150 replaces the source address from X.X.X.10 with Y.Y.Y.Y1 and retransmits the packets using network interface 224 towards 5G core network 120. Network interface 226 may be, for example, an Ethernet, Wi-Fi, or any other network interface that uses an IP network layer.

In some embodiments, proxy 120 may further include an IP adapter 228 to accommodate non-3GPP NAS incapable device 104 that does not use an IP-based network layer. In these embodiments, proxy 150 may receive, at its non-IP-based link and physical layers 230, a waveform transmitted by non-3GPP NAS incapable device 104. The layers 230 then sends the output (e.g., content of frames) to IP adapter 228, which packages the output as IP packets. In the example of FIG. 2, these IP packets have the source address X.X.X.11, and proxy 150 internally routes these packets to 5G core network 120 via network interface 224. When proxy 150 receives IP packets from 5G core network 120 intended for non-3GPP NAS incapable device 104 that is not IP-based, proxy 150 replaces the destination address (e.g., Y.Y.Y.Y1) of the received packets with the IP address of IP adapter 228 (e.g., X.X.X.11) and the packets are retransmitted towards IP adapter 228. The packets may be internally routed in the example of FIG. 2 where IP adapter 228 is internal to proxy 150. But, in some embodiments, IP adapter 228 may be external to proxy 150 and the packets may be routed to IP adapter 228 via an external network. After receiving the packets, IP adapter 228 extracts the payload within the received packets and transmits it as a waveform towards non-3GPP NAS incapable device 104 using non-IP link and physical layers 230. The IP adapter needs to extract the payload from the packets and place it into whatever format appropriate for the EUD recipient before delivering it to the EUD. For example, if the EUD supports PPP, then PPP frame should be used.

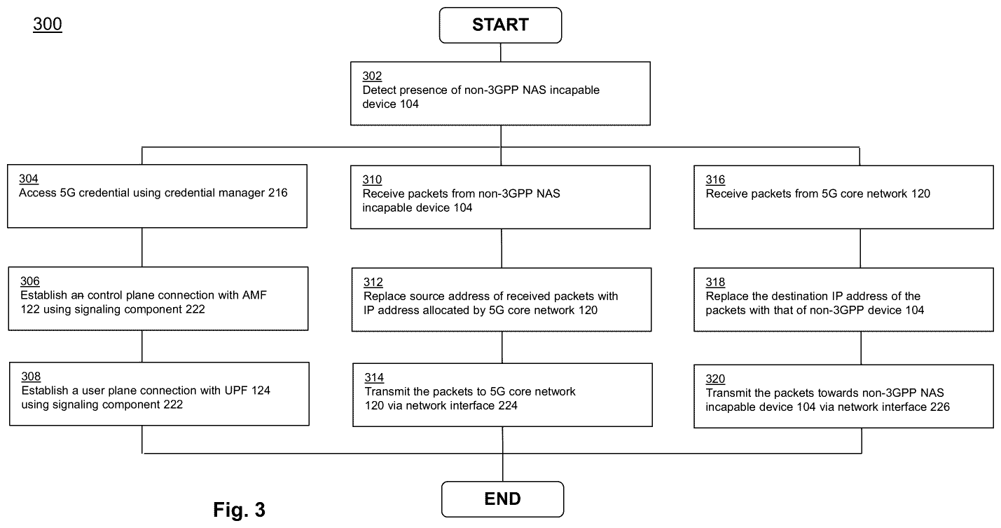

FIG. 3 illustrates a process 300 performed by a proxy 150 for enabling a non-3GPP NAS incapable device to communicate through a 5G core network 120, in accordance with some embodiments.

At step 302, EUD discovery component 212 of proxy 150 may detect a presence of non-3GPP NAS incapable device 104.

At step 304, credential manager 216 of proxy 150 may access a 5G credential. In some embodiments, credential manager 216 may have access to a plurality of 5G credentials, and credential manager 216 may select a 5G credential to access based on an identification of the non-3GPP NAS incapable device 104, a policy applied by a policy component 214, or a combination thereof.

At step 306, signaling component 222 of proxy 150 may establish a control plane connection with AMF 122 of 5G core network 120 using the 5G credential accessed at step 304.

At step 308, signaling component 222 of proxy 150 may establish a user plane connection with UPF 124 of 5G core network 120. In some embodiments, proxy 150 may receive an allocated IP address from 5G core network 120 as a part of this step. In some embodiments, proxy 150 may associate the allocated IP address with non-3GPP NAS incapable device 104 (e.g., using its identifier and/or an associated IP/MAC address) and/or the accessed 5G credential.

Steps 310-314 may be performed when proxy 150 receives data from non-3GPP NAS incapable device 104. At a step 310, network interface 226 of proxy 150 may receive packets originating from non-3GPP NAS incapable device 104. In embodiments where non-3GPP NAS incapable device 104 is not an IP-capable device, proxy 150 may receive the packets via an IP adapter 228. These IP packets may include, as the destination address, a private IP address not routable within 5G core network 120 or inaccessible via 5G core network 120 (e.g., within external data network 130).

At step 312, proxy 150 may replace the source address of the received packets with the IP address allocated by 5G core network 120.

At step 314, proxy 150 may transmit the packets to 5G core network 120 via network interface 224.

Steps 316-320 may be performed when proxy 150 receives data from 5G core network 120. At a step 316, network interface 224 of proxy 150 may receive IP packets from 5G core network 120. These packets may have, as the destination address, an IP address allocated by 5G core network 120. In these embodiments, proxy 150 may process these instructions, instead of, or in addition to, performing steps 318-320. In some embodiments, non-3GPP NAS incapable device 104 may be a unidirectional device or a device in a unidirectional mode. In these embodiments, proxy 150 may store the received packets or the payload inside of the received packets so that they can be accessed and/or transmitted at a later time.

At a step 318, proxy 150 may replace the destination IP address of the IP packets with the IP address of non-3GPP NAS incapable device 104, which proxy 150 may use to communicate with non-3GPP NAS incapable device 104 via network interface 226.

At a step 320, network interface 226 of proxy 150 may transmit the packets towards non-3GPP device 104. In embodiments where non-3GPP NAS incapable device 104 is not an IP-capable device, proxy 150 may forward the packets to an IP adapter 228.

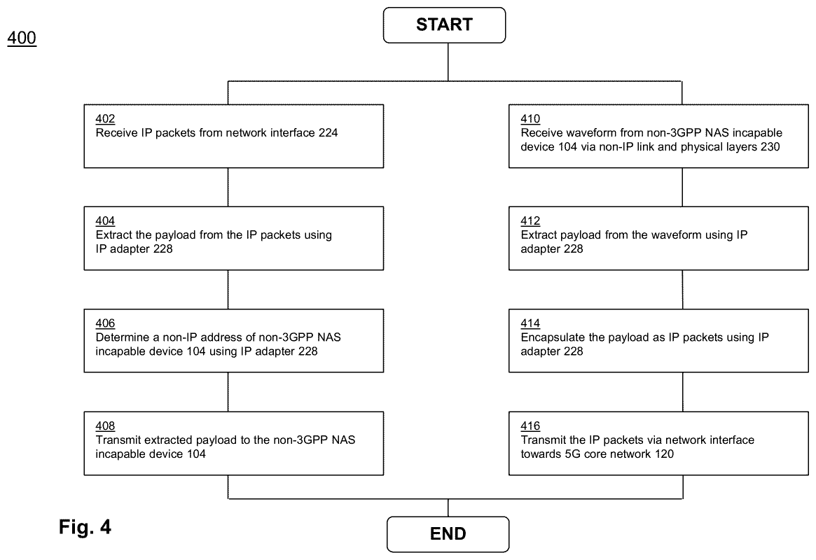

FIG. 4 shows a process 400 by an IP adapter 228 for enabling a non-3GPP NAS incapable device 104 that uses a non-IP-based network layer to communicate through 5G Core Network 120, in accordance with some embodiments. There are different approaches for a proxy to demultiplex incoming IP packets. For example, a proxy can reserve a pool of public IP addresses and assign one address to an EUD. As another example, a proxy may use different UDP/TCP ports to identify different EUDs. For address-based approach, the destination address in the incoming IP packets identify an EUD. For port-based approach, the UDP/TCP port number in the incoming IP packets identifies the EUD.

At step 402, IP adapter 228 may receive IP packets from network interface 224 (e.g., subsequent to step 320 of FIG. 3).

At step 404, IP adapter 228 may extract the payload from the IP packets.

At step 406, IP adapter 228 determines a non-IP address of non-3GPP NAS incapable device 104 based on the destination IP address, port, or a combination thereof. When the proxy encapsulates data from an EUD into IP packets, the proxy already makes a mapping between the EUD identity and the IP address and/or TCP/UDP port numbers in the IP packets. When an external IP packet comes in, the proxy extracts the destination IP address and/or the TCP/UDP port information and looks up the database of the mapping to find the corresponding EUD identity.

At step 408, IP adapter 228, using non-IP link and physical layers 230 and the non-IP address determined in step 406, transmits the extracted payload to the non-3GPP incapable device 104.

At step 410, IP adapter 228 may receive a waveform from non-3GPP NAS incapable device via non-IP link and physical layers 230.

At step 412, IP adapter 228 may extract the payload from the waveform.

At step 414, IP adapter 228 may encapsulate the payload as IP packets. The packets may have, as the source address, an IP address of the IP adapter 228. If the IP adapter uses one IP address for all the UEs attached to it, the proxy has to use TCP/UDP port to differentiate these UEs. In other words, the proxy has to construct a UDP/TCP packet instead of just an IP packet. On the other hand, if the proxy uses one IP address for each EUD, then the IP address itself is enough to identify different EUDs.

At step 416, IP adapter 228 may transmit the IP packets via network interface 224 towards 5G core network 120.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. In particular embodiments, a non-transitory computer- or machine-readable medium may be encoded with instructions in the form of machine instructions, hypertext markup language based instructions, or other applicable instructions to cause one or more data processors to perform operations. As used herein, the term “machine-readable medium” (or “computer-readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

In the descriptions above and in the claims, phrases such as “at least one of” or “one or more of” may occur followed by a conjunctive list of elements or features. The term “and/or” may also occur in a list of two or more elements or features. Unless otherwise Implicitly or Explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in methods, systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

We claim:

1. A proxy device for enabling a non-3GPP device without 3GPP signaling capability to communicate on a 3GPP-based communications network, comprising:
a physical layer configured to receive non-3GPP signaling waveforms from an end user device (EUD);
a network interface communicatively coupled to a 3GPP core network; and
one or more processors configured to:
establish a connection with the 3GPP-based core network using a 3GPP credential;
receive a first network address allocated by the 3GPP-based core network;
associate the first network address with the EUD;
extract a data payload from a waveform received from the EUD via the physical layer;
encapsulate the data payload in outgoing Internet Protocol (IP) packets, a source header of the outgoing IP packets including the first network address; and
transmit the IP packets to the 3GPP-based core network via the network interface.

2. The device of claim 1, wherein the 3GPP-based network is a 5G network, and one or more processors are configured to select the 5G credential among a plurality of 5G credentials based on (1) identity of the EUD, (2) protocol type of the waveform, or (3) a predetermined policy.

3. The device of claim 1, wherein the 3GPP-based network is a 5G network, and the one or more processors are further configured to:
receive incoming IP packets from the 5G core network intended for the EUD;
extract an incoming data payload from the incoming IP packets; and
transmit the incoming data payload as an outgoing waveform destined for the EUD using the physical layer.

4. The device of claim 3, wherein the 3GPP-based network is a 5G network, and the incoming data payload includes an instruction from the 5G core network to terminate the established connection, and wherein the one or more processors, in response to the data payload, terminates the established connection.

5. The device of claim 1, wherein the 3GPP-based network is a 5G network and establishing the connection includes establishing a control plane connection and a user plane connection with the 5G core network.

6. The device of claim 1, wherein one or more processors are configured to associate a second EUD with the first network address.

7. The device of claim 1, wherein the 3GPP-based network is a 5G network, and the proxy is configured to respond to a message intended to detect liveness of peers to maintain a connection with the 5G core network.

8. A method for enabling a non-3GPP end user device (EUD) without 3GPP signaling capability to communicate on a 3GPP-based communications network, comprising:
establishing a connection with a 3GPP-based core network using a 5G credential;
receiving a first network address allocated by the 3GPP-based core network;
associating the first network address with the EUD;
extracting a data payload from a waveform received from the EUD via a physical layer configured to receive non-3GPP signaling waveforms from the EUD;
encapsulating the data payload in outgoing Internet Protocol packets, a source header of the outgoing IP packets including the first network address; and
transmitting the IP packets to the 3GPP-based core network via the network interface.

9. The method of claim 8, wherein the 3GPP-based network is a 5G network and the one or more processors are configured to select the 5G credential among a plurality of 5G credentials based on (1) identity of the UE, (2) protocol type of the waveform, or (3) a predetermined policy.

10. The method of claim 8, wherein the 3GPP-based network is a 5G network and the one or more processors are further configured to:
receive incoming IP packets from the 5G core network intended for the EUD;
extract an incoming data payload from the incoming IP packets;
transmit the incoming data payload as an outgoing waveform destined for the EUD using the physical layer.

11. The method of claim 10, wherein the 3GPP-based network is a 5G network and the incoming data payload includes an instruction from the 5G core network to terminate the established connection, and wherein the one or more processors, in response to the data payload, terminates the established connection.

12. The method of claim 8, wherein the 3GPP-based network is a 5G network and establishing the connection includes establishing a control plane connection and a user plane connection with the 5G core network.

13. The method of claim 8, wherein one or more processors are configured to associate a second UE with the first network address.

14. The method of claim 8, wherein the 3GPP-based network is a 5G network and the proxy is configured to respond to a message intended to detect liveness of peers to maintain a connection with the 5G core network.

15. A storage medium storing instructions that when executed by a device cause the device to perform a method for integrating a non-3GPP device without 3GPP signaling into a 5G network, the method comprising:
establishing a connection with a 3GPP-based core network using a 5G credential;
receiving a first network address allocated by the 3GPP-based core network;
associating the first network address with the EUD;
extracting a data payload from a waveform received from the EUD via a physical layer configured to receive non-3GPP signaling waveforms from the EUD;
encapsulating the data payload in outgoing Internet Protocol packets, a source header of the outgoing IP packets including the first network address; and
transmitting the IP packets to the 3GPP-based core network via the network interface.

16. The storage medium of claim 15, wherein the 3GPP-based network is a 5G network and the one or more processors are configured to select the 5G credential among a plurality of 5G credentials based on (1) identity of the EUD, (2) protocol type of the waveform, or (3) a predetermined policy.

17. The storage medium of claim 15, wherein the 3GPP-based network is a 5G network and the one or more processors are further configured to:
receive incoming IP packets from the 5G core network intended for the EUD;
extract an incoming data payload from the incoming IP packets;
transmit the incoming data payload as an outgoing waveform destined for the EUD using the physical layer.

18. The storage medium of claim 15, wherein the 3GPP-based network is a 5G network and the incoming data payload includes an instruction from the 5G core network to terminate the established connection, and wherein the one or more processors, in response to the data payload, terminates the established connection.

19. The storage medium of claim 15, wherein the 3GPP-based network is a 5G network and establishing the connection includes establishing a control plane connection and a user plane connection with the 5G core network.

20. The storage medium of claim 15, wherein one or more processors are configured to associate a second EUD with the first network address.
